(19) United States
(12) Patent Application Publication
(10) Pub. No.: US 2017/0115087 A1
(43) Pub. Date: Apr. 27, 2017

(54) MOUNTING BRACKET

(71) Applicant: Dominic Di Carlo, Sarnia (CA)

(72) Inventor: Dominic Di Carlo, Sarnia (CA)

(21) Appl. No.: 14/921,009

(22) Filed: Oct. 23, 2015

(51) Int. Cl. F41A 23/26; B60R 7/04

(52) U.S. Cl. CPC F41A 23/26; B60R 7/046

(57) ABSTRACT

An adjustable rifle-holding device is adapted for use in a vehicle and can be adjusted to support different sizes and types of rifles. The rifle-holding device allows easy access to a stored rifle to authorized users. The rifle holder or rack will accommodate a variety of rifles and shotguns. A rifle may then be inserted into the holding device, and is securely held there for increased safety and protection of the rifle, while still permitting very rapid access to the rifle when desired.

### CROSS REFERENCE TO RELATED APPLICATIONS

Not applicable.

### FEDERALLY SPONSORED RESEARCH & DEVELOPMENT

Not applicable.

### MICROFICHE APPENDIX

Not applicable.

### BACKGROUND OF THE INVENTION

(1) Field of the Invention

The present invention relates to transporting rifles and other shotguns to and from hunting expeditions, target practice, or other destinations. More specifically, the present invention provides an adjustable and removable gun rack for securely storing rifles during transit.

(2) Background of the Invention

Many individuals are hunters who derive great pleasure from hunting and other outdoor activities associated thereto. Individuals may hunt for sport or recreation, while others hunt animals as a source of sustenance. Some hunters choose to hunt with a bow and arrow; however, the most popular hunting means is a rifle. The present invention is related to the transportation of a rifle or similar weapon to and from a hunting area and, further, for general weapon transport in areas where storage of a gun within a vehicle is permitted.

Structures that support rifles and shotguns are typically employed at shooting ranges and other locations where a shooter is generally expected to stand in one place or near a fixed location for extended periods of time. Skeet ranges illustrate one example, where the shooter is either engaged in holding a shotgun during shooting or is not shooting. When not shooting, the shooter seeks to put the shotgun down and may usually have available a specialized rack for cradling and holding the shotgun.

U.S. Pat. No. 6,405,909, to Burnett, describes a gun rack that attaches to the backside of a vehicle seat to securely store rifles during transit. The device has a set of rifle-holding pockets stacked one on top of the next. Each rifle holding pocket allows for a user to insert a rifle through the pocket. A rifle rests in the pocket during transport in a horizontal orientation. At the top of the series of rifle-holding pockets is a loop that is placed over the head rest of a seat in a vehicle.

U.S. Pat. No. 5,495,969, to Cardenas, describes another gun rack that mounts to the backside of a vehicle's backseat. The Cardenas device can hold multiple rifles, but is limited to use in vehicles wherein there is a backseat and a space behind the backseat to store the device while holding the guns. The device sits behind the backseat of a vehicle at an angle such that the muzzles of the rifles that are harnessed into the device and are pointed towards the interior ceiling of the vehicle.

U.S. Pat. No. 6,279,799, to Horton, describes an adjustable gun rack that straps to a bench seat in a vehicle. The device is capable of holding a single rifle oriented in a horizontal position. It can either strap to the backside of a bench seat, or to the front of the seat portion of a bench seat in a vehicle—the area where a passenger seated on the bench seat may rest their legs. The device has two straps that attach to the rifle-holding case by a hook system, such as a carabineer and receiving grommet. The two straps are adjustable and can wrap around the back support portion of a bench seat to secure the device to the backside of a bench seat, or to the seat cushion of a bench seat to secure the device to the front of the seat portion in a bench seat in a vehicle. The rifle rests in a padded rifle holding pouch that zips shut. The device serves dual purposes. The rifle holding case, in conjunction with one of the adjustable straps, can serve as an over-the-shoulder gun tote during a hunting expedition, or as a case for storage during transport in a vehicle.

With space at a premium, it is desirable to have a gun mount for a vehicle that can easily be adjusted to secure a variety of different sizes and types of rifles.

The present invention provides an adjustable gun mount that can securely hold multiple rifles and that can be quickly adjusted to hold different types and sizes of rifles. In addition, the rifles can be securely locked to the gun mount to deter theft or unauthorized use.

### SUMMARY OF THE INVENTION

The present invention provides a new removable rifle rack wherein the same can be utilized for providing convenient and secure storage of rifles during transportation of the rifles in a private vehicle.

The present invention is directed to a device for holding rifles or shotguns in vehicles that allows easy access when the door is opened.

The device of this invention includes a device for holding rifles or shotguns in vehicles that is a removable and adjustable rifle holding device that utilizes the vehicle door as a support for an upstanding rifle holder.

The device is easy to use, as this improved rifle-holding device accommodates a number of rifles and shotguns without adjustment, but it could be easily adjustable according to the requirement of user.

As described above, the functional improved rifle-holding device is made of aluminum and other metals. A final objective of the present invention is to provide a vehicle rifle-holding device that can retain and secure rifles as well as shotguns.

Other features and advantages of the present invention will become more apparent from the following detailed description when taken in conjunction with the accompanying drawings, which illustrate, by way of example, the principles of the invention.

### BRIEF DESCRIPTION OF THE DRAWINGS

To further clarify various aspects of some example embodiments of the present invention, a more particular description of the invention will be rendered by reference to specific embodiments thereof, which are illustrated in the appended drawing. It is appreciated that the drawing depicts only illustrated embodiments of the invention, and is, therefore, not to be considered limiting of its scope. The invention will be described and explained with additional specificity and detail through the use of the accompanying drawing, in which:

FIG. 1 is a diagram illustrating the improved rifle or gun support brackets of the present invention.

FIG. 2 depicts a rifle holder.

### DETAILED DESCRIPTION OF THE INVENTION

The following detailed description refers to the accompanying drawings that illustrate the embodiments of the present invention. Other embodiments are possible and modifications may be made to the embodiments without departing from the spirit and scope of the invention. Therefore, the following detailed description is not meant to limit the invention. Rather, the scope of the invention is defined by the appended claims.

A rifle holder is used to hold or restrict the undesired movement of a rifle or other guns, most commonly in a location where it can be easily withdrawn for immediate use in different purposes, such as hunting, etc.

The device provided in the present invention is a rifle holder with a vertical rod-shaped support member, horizontal ground stabilizer bar, and a gun holder.

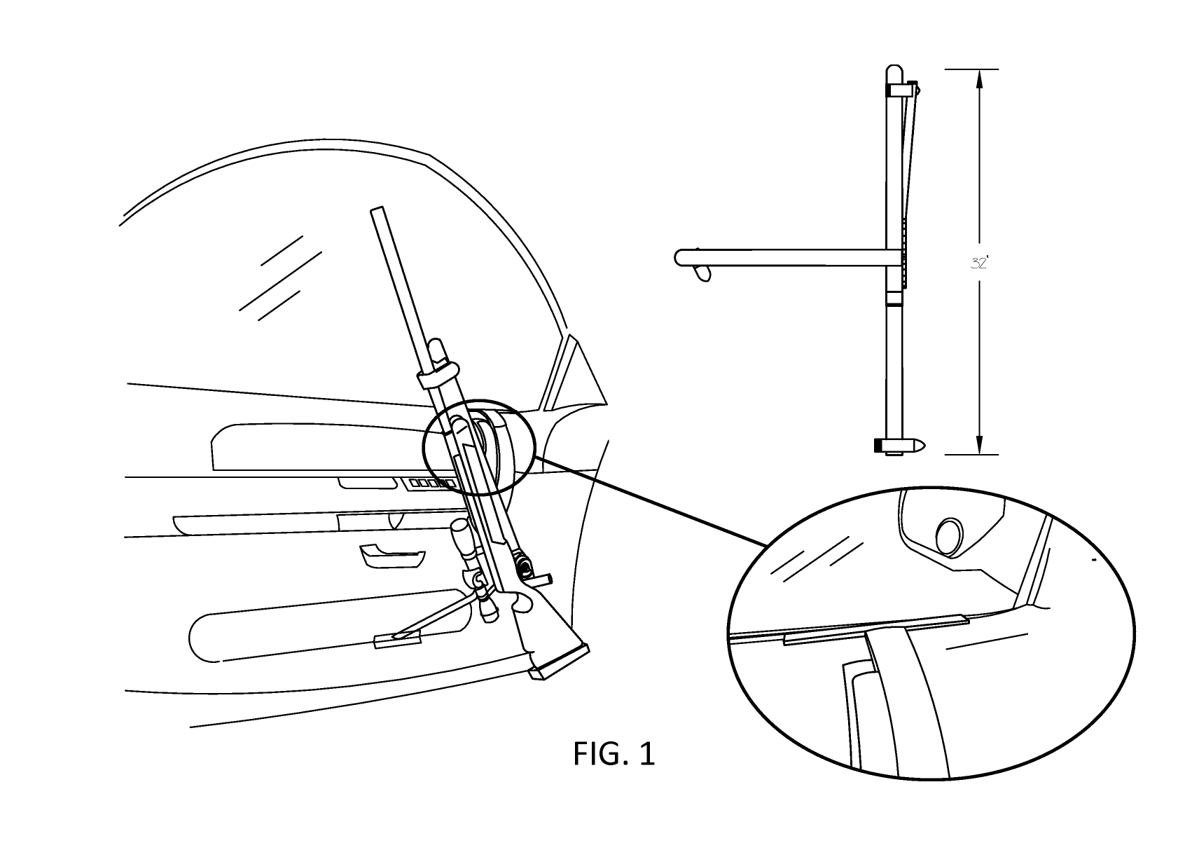

The disclosed invention is an improved device for holding rifles or shotguns in a vehicle's door FIG. 1 that is removable, adjustable, and utilizes the vehicle door as a support for an upstanding rifle holder. The device is attached on the top of the door byt one side. The other side of the device rests on bottom pocket of the door.

The rifle-holding device accommodates a number of different sizes of rifles and other shotguns without adjustments, but it also could be adjusted easily, according to the requirement of user.

The above described improved rifle-holding device is made of aluminum and other metals. The main advantage of the present invention is that it provides a vehicle rifle-holding device that can retain and secure rifles as well as shotguns. Another advantage of the present invention is easy access of rifles and other shotguns when the user opens the vehicle's door. This saves time during hunting.

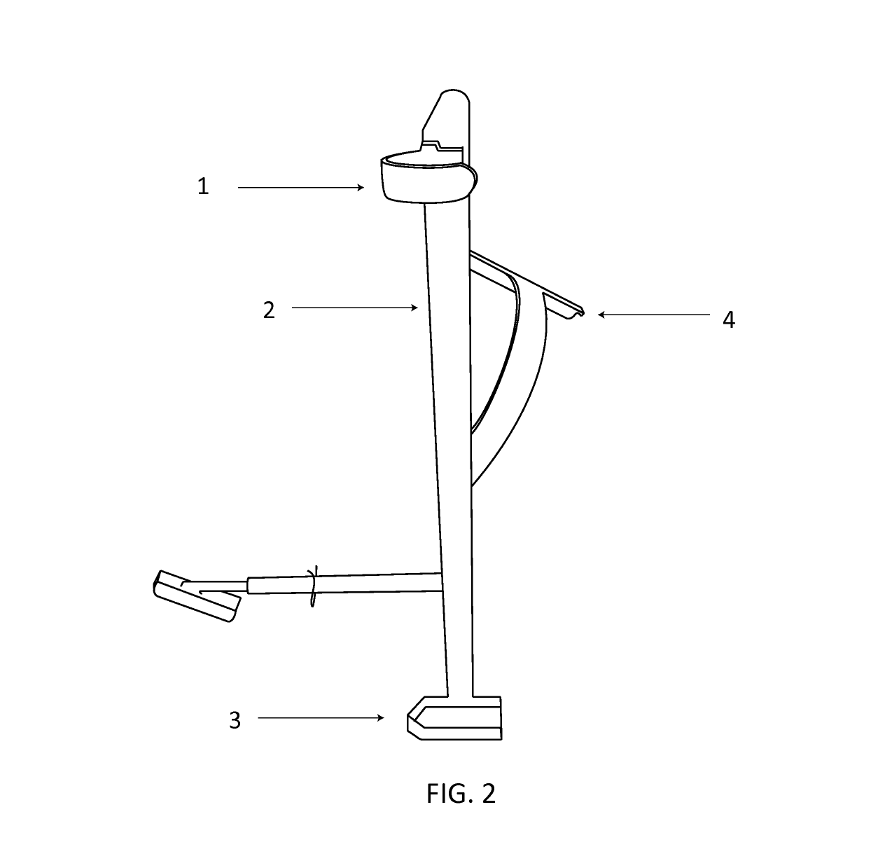

More specifically, and referring to the FIG. 2, the rifle holding device 1 is comprised of a vertical rod-shaped support member 2, horizontal ground stabilizer bar 3, and a gun holder 4. The horizontal bar serves as the base for the device once the first and second vertical rod are inserted into the door within a motor vehicle.

The present invention is not meant to be limited to merely the holding of rifles. The device may also be used to hold other guns and elongated objects during transit. Some examples include rifles and shotguns, if the holding of such devices is desired by the user.

It is to be understood that the above description is intended to be illustrative, and not restrictive. For example, the above-discussed embodiments may be used in combination with each other. Many other embodiments will be apparent to those of skill in the art upon reviewing the above description. It is to be understood that the above description is intended to be illustrative, and not restrictive. For example, the above-discussed embodiments may be used in combination with each other. Many other embodiments will be apparent to those of skill in the art upon reviewing the above description.

Plural instances may be provided for components, operations, or structures described herein as a single instance. Finally, boundaries between various components are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

I claim:

1. A rifle-holding device for holding a rifle in a holding device for supporting a hunter's gun while hunting comprising:
(a) a vertical rod-shaped support member that has an adjustable length and that has a lower pointed end wedgeable in the ground;
(b) a horizontal ground stabilizer bar that is perpendicularly coupled to said vertical rod-shaped support member for maintaining said vertical rod-shaped support member in a horizontal position; and,
(c) a gun holder that is coupled to said vertical rod-shaped support member, which supports a longitudinal length of the rifle in a horizontal plane or an upright position.

2. The rifle-holding device as in claim 1, wherein said the rifle-holding device is made of aluminum.

3. The rifle-holding device as in claim 1, wherein said the rifle-holding device is able to accommodate different sizes of rifles and shotguns.

4. The rifle-holding device, as in claim 1, wherein said rifle-holding device is made for vehicles door.

5. The rifle-holding device as in claim 1, wherein said rifle-holding device is attached on the top of the vehicle's door side, while the lower part is attached on bottom pocket of the vehicle.
